(19) United States
(12) Patent Application Publication
(10) Pub. No.: US 2023/0119682 A1
(43) Pub. Date: Apr. 20, 2023

(54) CALIBRATION OF QUANTUM MEASUREMENT DEVICE

(71) Applicant: BEIJING BAIDU NETCOM SCIENCE TECHNOLOGY CO., LTD., Beijing (CN)

(72) Inventor: Kun Wang, Beijing (CN)

(73) Assignee: BEIJING BAIDU NETCOM SCIENCE TECHNOLOGY CO., LTD., Beijing (CN)

(21) Appl. No.: 17/954,245

(22) Filed: Sep. 27, 2022

(30) Foreign Application Priority Data
Sep. 29, 2021 (CN) 202111154131.1

(51) Int. Cl. G06N 10/20

(52) U.S. Cl. CPC G06N 10/20

(57) ABSTRACT

A method is provided. The method includes: preparing one or more standard basis quantum states denoted by |y >, and for each of the standard basis quantum states, repeatedly operating a measurement device a predetermined number of times to perform measurements on that the each standard basis quantum state; counting the predetermined number of measurement results, of each of the standard basis quantum states, to construct a calibration matrix; determining the number of zero elements of each column in the calibration matrix; determining a correction coefficient corresponding to each column based on the number of zero elements, where the correction coefficient is inversely proportional to the number of zero elements; and constructing a new calibration matrix based on the correction coefficient corresponding to the each column, to correct a measurement result of the measurement device based on the new calibration matrix.

### CROSS REFERENCE TO RELATED APPLICATIONS

The present application claims priority to Chinese Patent Application No. 202111154131.1 filed on Sep. 29, 2021, the content of which is hereby incorporated by reference in its entirety for all purposes.

### TECHNICAL FIELD

The present disclosure relates to the field of computers, in particular to the technical field of quantum computers, and specifically to a method and an apparatus for calibrating a quantum measurement device, an electronic device, a computer-readable storage medium, and a computer program product.

### BACKGROUND

The quantum computer technology has developed rapidly in recent years, but in the foreseeable future, a noise problem of a quantum computer is inevitable: heat dissipation in qubit or random fluctuations in a lower-level quantum physical process will flip or randomize a qubit state, and a deviation of a computation result read by a measurement device may lead to failure of a computation process.

At present, the technical solution for calibrating a quantum measurement device may be divided into the following two categories according to an assumption of a calibration matrix structure: a tensor product model and a complete model. In the tensor product model, it is required to assume that n qubit measurement devices do not affect each other, and therefore, a calibration matrix cannot be accurately characterized. The complete model solves problems of the tensor product model well, but it may lead to a “null event”, which also makes it impossible to accurately characterize the calibration matrix.

### SUMMARY

The present disclosure provides a method and an apparatus for calibrating a quantum measurement device, an electronic device, a computer-readable storage medium, and a computer program product.

According to an aspect of the present disclosure, there is provided a method for calibrating a quantum measurement device, the method including: preparing one or more standard basis quantum states denoted by |y >, and for each of the standard basis quantum states, repeatedly operating a measurement device a predetermined number of times to perform measurements on that the each standard basis quantum state, to obtain the predetermined number of measurement results, where y ∈ {0,1)ⁿ, n is the number of qubits of a quantum computer, and n is a positive integer; counting the predetermined number of measurement results, of each of the standard basis quantum states, to construct a calibration matrix: determining the number of zero elements of each column in the calibration matrix; determining a correction coefficient corresponding to the each column based on the number of zero elements, wherein the correction coefficient is inversely proportional to the number of zero elements; and constructing a new calibration matrix based on the correction coefficient corresponding to the each column, to correct a measurement result of the measurement device based on the new calibration matrix.

According to another aspect of the present disclosure, there is provided an electronic device, including: a memory storing one or more programs configured to be executed by one or more processors, the one or more programs including instructions for causing the electronic device to perform operations comprising: preparing one or more standard basis quantum states denoted by ly >; for each of the standard basis quantum states, repeatedly operating a measurement device a predetermined number of times to perform measurements on that the each standard basis quantum state, to obtain the predetermined number of measurement results, where y ∈ {0,1}ⁿ, n is the number of qubits of a quantum computer, and n is a positive integer; counting the predetermined number of measurement results, of each of the standard basis quantum states, to construct a calibration matrix; determining the number of zero elements of each column in the calibration matrix: determining a correction coefficient corresponding to the each column based on the number of zero elements, wherein the correction coefficient is inversely proportional to the number of zero elements: and constructing a new calibration matrix based on the correction coefficient corresponding to the each column, to correct a measurement result of the measurement device based on the new calibration matrix.

According to another aspect of the present disclosure, there is provided a non-transitory computer-readable storage medium that stores one or more programs comprising instructions that, when executed by one or more processors of an electronic device, cause the electronic device to implement operations comprising: preparing one or more standard basis quantum states denoted by |y >; for each of the standard basis quantum states, repeatedly operating a measurement device a predetermined number of times to perform measurements on that the each standard basis quantum state, to obtain the predetermined number of measurement results, where y ∈ {0,1}ⁿ, n is the number of qubits of a quantum computer, and n is a positive integer; counting the predetermined number of measurement results, of each of the standard basis quantum states, to construct a calibration matrix: determining the number of zero elements of each column in the calibration matrix; determining a correction coefficient corresponding to the each column based on the number of zero elements, wherein the correction coefficient is inversely proportional to the number of zero elements; and constructing a new calibration matrix based on the correction coefficient corresponding to the each column, to correct a measurement result of the measurement device based on the new calibration matrix.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The drawings show embodiments by way of example and form a part of the specification, and are used to explain example implementations of the embodiments together with a written description of the specification. The embodiments shown are merely for illustrative purposes and do not limit the scope of the claims. Throughout the drawings, identical reference signs denote similar but not necessarily identical elements.

FIG. 1 is a schematic diagram of a system in which various methods described herein can be implemented according to an embodiment of the present disclosure,

FIG. 2 is a processing flowchart of measurement noise of a quantum measurement device according to an embodiment of the present disclosure;

FIG. 3 is a flowchart of a method for calibrating a quantum measurement device according to an embodiment of the present disclosure:

FIG. 4 is a structural block diagram of an apparatus for calibrating a quantum measurement device according to an embodiment of the present disclosure; and

FIG. 5 is a structural block diagram of an exemplary electronic device that can be used to implement an embodiment of the present disclosure.

### DETAILED DESCRIPTION

Embodiments of the present disclosure are described below in conjunction with the accompanying drawings, where various details of the embodiments of the present disclosure are included to facilitate understanding, and should only be considered as an example. Therefore, those of ordinary skill in the art should be aware that various changes and modifications can be made to the embodiments described herein, without departing from the scope of the present disclosure. Likewise, for clarity and conciseness, description of well-known functions and structures are omitted in the following descriptions.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

Embodiments of the present disclosure will be described below in detail in conjunction with the drawings.

So far, various types of computers in application all use classical physics as a theoretical basis for information processing, and are referred to as conventional computers or classical computers. Binary data bits that are easiest to implement physically are used by a classical information system to store data or programs. Each binary data bit is represented by 0 or 1 and referred to as a bit, and is the smallest information unit. The classical computers themselves have the inevitable disadvantages as follows. First, as a most basic limitation of energy consumption in a computation process Minimum energy required by a logic element or a storage unit should be several times more than kT (where k represents the Boltzmann constant and T represents the temperature) to avoid malfunction under thermal fluctuations. The second disadvantage is related to information entropy and heating energy consumption. And third under a very high routing density of computer chips, according to the Heisenberg’s uncertainty principle, if uncertainty of electronic positions is very low, uncertainty of a momentum is very high. Electrons are no longer bound and this have a quantum interference effect. Such an effect may even damage performance of chips.

Quantum computers are a type of physical devices that abide by the properties and laws of quantum mechanics to perform high-speed mathematical and logical computation, and store and process quantum information. When a device processes and computes quantum information and runs a quantum algorithm, the device is a quantum computer. The quantum computers abide by a unique quantum dynamics law (especially quantum interference) to implement a new mode of information processing. For parallel processing of computing problems, the quantum computers have an absolute advantage in speed than classical computers. A transformation of each superposition component performed by the quantum computers is equivalent to a classical computation. All these classical computations are completed simultaneously and superposed based on a specific probability amplitude, and an output result of the quantum computers is provided. Such computation is referred to as a quantum parallel computation. Quantum parallel processing greatly improves efficiency of the quantum computers and causes the quantum computers to complete operations that classical computers cannot complete, for example, factorization of a quite large natural number. Quantum coherence is essentially utilized in all ultrafast quantum algorithms. Therefore, quantum parallel computations with quantum states replacing classical states can achieve an incomparable computation speed and an incomparable information processing function than the classical computers and also save a large amount of computation resources.

With rapid development of the quantum computer technology, due to the powerful computing capability and fast running speed, an application range of a quantum computer becomes wider and wider. For example, chemical simulation is a process of mapping Hamiltonian of a real chemical system to physically operable Hamiltonian, and then modulating parameters and evolution time to find an eigenstate that may reflect the real chemical system. When an N-electron chemical system is simulated on a classical computer, solving of a 2^{N}-dimensional Schrodinger equation is involved, and a computation amount may increase exponentially with increase of the number of electrons in the system. Therefore, the role of the classical computer in chemical simulation is very limited, which can only be broken by means of a powerful computing capability of a quantum computer. A variational quantum eigensolver (VQE) is an efficient quantum algorithm for performing chemical simulation on quantum hardware, and is one of the most promising applications of quantum computers in the near future, opening up many new fields of chemical research. However, at present, a measurement noise rate of a quantum computer obviously limits a function of the VQE, so it is desirable to first solve a problem of quantum measurement noise.

A core computation process of the VQE is to estimate an expected value Tr[Oρ], where ρ is an n-qubit quantum state generated by a quantum computer, and an n-qubit observable O is physically operable Hamiltonian mapped from Hamiltonian of a real chemical system. The foregoing process is a most general form of extracting classical information through quantum computation and a core step of reading the classical information from quantum information. Generally, it can be assumed that O is a diagonal matrix under a computing base, and therefore, theoretically, the expected value Tr[Oρ] may be computed according to formula (1):

$$T r \left[O ρ\right] = \sum {}_{i = 0}^{{2}^{n} - 1} O \left(i\right) ρ \left(i\right)$$

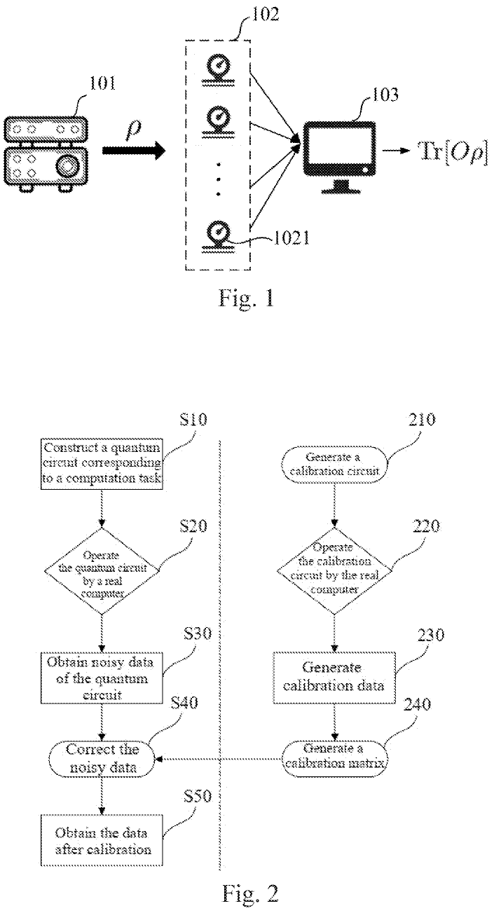

Here, O(į) represents an element in row į and column į of O (assuming that an index of a matrix element starts from 0). The foregoing quantum computation process may be shown in FIG. 1, where a process of generating an n-qubit quantum state ρ by a quantum computer 101 and measuring the quantum state ρ by a measurement device 102 to obtain a computation result is executed M times, and the number of times M_{į} a result į is output is counted, to estimate ρ(į) ≈ Mį/M, and then Tr[Oρ] may be estimated by a classical computer 103. For example, the measurement device 102 may measure the n-qubit quantum state P by using n (a positive integer) single-qubit measurement devices 1021 to obtain a measurement result. The law of large numbers may ensure that the foregoing estimation process is correct when M is large enough.

However, in a physical implementation, due to limitations of various factors such as instruments, methods, and conditions, a measurement device cannot work accurately, resulting in measurement noise, which makes a deviation between actually estimated values Mį/M and ρ(i), causing errors in computing Tr[Oρ] with formula (1). The main problem is that the number of times M_{į} that the result i is an output is counted inaccurately due to measurement errors. Experimentally, there are two main sources of noise in quantum measurement, one is that a thermal fluctuation effect of a resonator itself and the noise generated in the measurement process may affect distinguishability of different states, and the other is that qubits degenerate from an excited state to a ground state causes an incorrect reading result. Therefore, how to reduce impact of measurement noise to obtain an unbiased estimation of Tr[Oρ] has become an urgent problem to be solved.

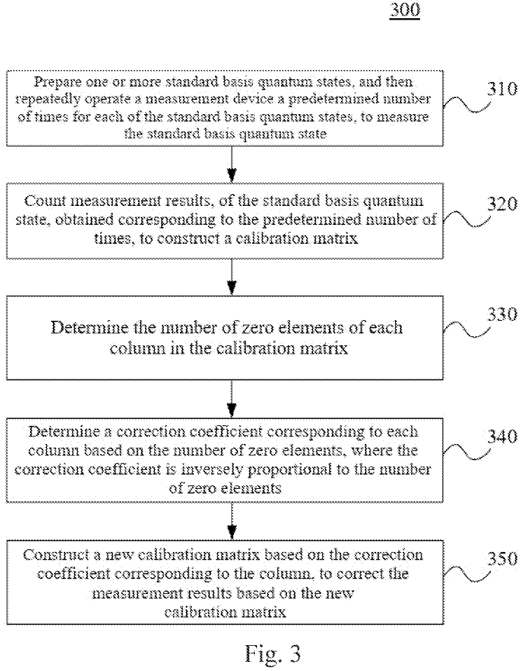

Generally, a measurement device may be calibrated and then an output result of the measurement device may be corrected. A working process may be shown in FIG. 2. In a basic process of measurement noise processing, an experimenter prepares many calibration circuits (step 210), and then operates the calibration circuits in an actual measurement device (step 220), to detect basic information of the measurement device. Specifically, in a system shown in FIG. 1, a corresponding calibration circuit may be constructed by the quantum computer 101, to obtain a corresponding standard basis quantum state. The standard basis quantum state is measured a plurality of times by the measurement device 102 to generate calibration data (step 230).

The generated calibration data may be used to construct a calibration matrix A (step 240), and the matrix characterizes noise information of a noisy measurement device. Then, when a specific quantum computation task needs to be executed, a quantum circuit corresponding to the computation task may be constructed (step S10), a quantum circuit corresponding to the task may be operated in an actual device (step S20), and noisy output data {N_{į}}_{į} of the quantum circuit may be obtained (step S30). Then, the noisy data may be post-processed by using an obtained calibration matrix A (step S40):

$$\text{q=} \left(\begin{matrix}{N}_{0} / N \\ {N}_{1} / N \\ ⋮ \\ {N}_{2} {n}_{- 1} / N\end{matrix}\right) , \text{p} = {A}^{- 1} \text{q}$$

Here, A⁻¹ represents the inverse of the calibration matrix A. A calibrated probability distribution p approximates to {ρ(į)}_{į},and further, an expected value Tr[Oρ] is computed (step S50), which improves accuracy of computing the expected value.

It may be seen from the basic process of measurement noise processing shown in FIG. 2 that a process of constructing a calibration matrix A based on calibration data is very critical, quality of A directly affects the calibrated probability distribution p, and then accuracy of an expected value Tr[Oρ] is determined.

At present, a process of generating a calibration matrix A based on calibration data may be divided to the following two categories according to an assumption of a calibration matrix structure: a tensor product model and a complete model. In the tensor product model, an experimenter assumes that in the computation task shown in FIG. 1, the n qubit measurement devices do not affect each other, so only calibration matrices {Aₖ}ₖ of the qubit measurement devices need to be computed separately based on the calibration data, where k = 1, ··· , n. Here, A_{κ} is a 2 × 2 column random matrix, and then a system calibration matrix with a dimension 2ⁿ × 2ⁿ may be obtained by performing a tensor operation on the n matrices:

$$A = {⊗}_{k = 1}^{n} {A}_{k}$$

It may be seen that in the tensor product model, a calibration process may be greatly simplified after a tensor assumption is made for the calibration matrix A. However, in a physical experiment, a large amount of experimental data show that an interaction between qubits and an environment is enhanced due to coupling between qubits and a resonator, such that decoherence and dephasing of qubits become more severe, and crosstalk of qubit measurement results may occur. Therefore, the tensor product model cannot accurately characterize the calibration matrix A. In order to solve a crosstalk problem between qubits, the complete model does not make any structural assumption about the calibration matrix A. but directly deduces properties of a quantum measurement device from the calibration data. The operation process thereof specifically includes the following steps: a standard basis quantum state ly > is prepared, where y ∈ {0,1}ⁿ. With |y > as input of a noisy measurement device, the noisy measurement device is repeatedly operated Nₛₕₒₜₛ times, and the number of times N_{x|y} output results are binary strings x is counted, where x ∈ {0,1}ⁿ. According to the definition,

$${N}_{s h o t} = \sum {}_{x = 0}^{{2}^{n} - 1} {N}_{x \left|y\right)}$$

Elements of column y in the calibration matrix A are computed by using a dataset {N_{x|y}}_{x,y}. It is assumed that A_{xy} represents an element of row x and column y in the 2ⁿ × 2ⁿ matrix A, and has a value as follows:

$${A}_{x y} = \frac{{N}_{x \left|y\right)}}{{N}_{s h o t s}}$$

All x ∈ {0,1}ⁿ may be enumerated to compute column y in the calibration matrix A. All y ∈ {0,1}ⁿ may be enumerated to compute elements of all columns in A. Formula (4) ensures that column y in the calibration matrix A constructed as above satisfies a column random property. It should be emphasized that formula (5) is an optimal solution given by a maximum likelihood estimation method. Obviously, a larger total number of repetitions Nₛₕₒₜₛ leads to more accurate characterization of a noise matrix A. but leads to more quantum detection circuits that need to be prepared, and higher computation overheads.

As mentioned above, the complete model may well solve problems of the tensor product model well, but Nₛₕₒₜₛ should not be set too large, otherwise the number of ground states that need to be repeatedly prepared and the total number of times a noisy measurement device is operated may be very large, and the computation resource overheads may be too high. The limitation is likely to lead to a “null event”: when formula (5) is used, A_{xy} = 0 is caused by N_{x|y} = 0. Mathematically, a null event means that in subsequent data processing, the event “an input quantum state is ly > and an output result is x” may never happen, which leads to serious problems when p = A⁻¹q is used to deduce a correct probability p.

A null event reflects the objective law of a measurement device, that is, such a measurement crosstalk error does not exist at all This case is possible if accuracy of a quantum measurement device is high enough. Moreover, due to limitations and one-sidedness of detection of a calibration circuit of a noisy quantum measurement device and a scale and a distribution of measurement results of the calibration circuit, many possible measurement crosstalk errors do not appear in the measurement results. Only increasing Nₛₕₒₜₛ cannot fundamentally solve the problem of insufficient sampling data.

To avoid a “null event”, as shown in FIG. 3, according to an embodiment of the present disclosure, there is provided a method 300 for calibrating a quantum measurement device, the method including: preparing one or more standard basis quantum states denoted by ly >, and for each of the standard basis quantum states, repeatedly operating a measurement device a predetermined number of times to perform measurements on the each standard basis quantum state, to obtain the predetermined number of measurement results (step 310); counting the predetermined number of measurement results, of each of the standard basis quantum states, to construct a calibration matrix (step 320); determining the number of zero elements of each column in the calibration matrix (step 330); determining a correction coefficient corresponding to the each column based on the number of zero elements, where the correction coefficient is inversely proportional to the number of zero elements (step 340); and constructing a new calibration matrix based on the correction coefficient corresponding to the each column, to correct a measurement result of the measurement device based on the new calibration matrix (step 350).

According to embodiments of the present disclosure, a correction coefficient is introduced, a small probability is increased while a large probability is reduced so that a probability distribution tends to be uniform as much as possible, and therefore, more accurate probability distribution may be used to adjust a maximum likelihood estimation result.

Specifically, it is assumed that the number of times N_{x|y} of an output result x is obtained after a calibration circuit ly > is operated Nₛₕₒₜₛ times , and then it is assumed that the number of times x is observed is more than the actually counted number of times by β_{y} (referred to as “correction coefficient”), that is, the number of times the output result x is actually recorded is N_{x|y} + _{βy}. The correction coefficient β_{y} enables each output result x to be observed at least β_{y} times.

Therefore, according to some embodiments, in order to avoid occurrence of a “null event”, the statistical additive smoothing technology is used Specifically, a new calibration matrix may be constructed according to formula (6):

$${\overline{A}}_{x y} = \frac{{N}_{\left(x\right| y} + {β}_{y}}{{N}_{s h o t s} + {2}^{n} {β}_{y}}$$

where A̅_{xy} is an element of row x and column y in the new calibration matrix, N_{x|y} is the number of times that the measurement result is obtained of x after inputting a standard basis quantum state |y >, Nₛₕₒₜₛ is the predetermined number of times, and β_{y} is a correction coefficient corresponding to the column y.

In some examples, the predetermined number of times Nₛₕₒₜₛ may be set in advance by an experimenter according to a property of the device, and is not limited herein.

It may be understood that in a limit case, N_{x|y}=0 (that is, no output result x is obtained in operation results of Nₛₕₒₜₛ), A̅_{xy} ≈ β_{y}/Nₛₕₒₜₛ > 0, which avoids a zero probability value while conforming to an intuition that “A̅_{xy} needs to be small”. It should be emphasized that formula (6) is essentially still an optimal solution given for a new dataset in the maximum likelihood estimation method.

Obviously, selection of a correction coefficient depends on physical properties of a measurement device, more specifically: if a null event reflects the objective law of a measurement device, β_{y} needs to be close to 0, that is, it is desirable to avoid “artificially” increasing the number of observation times and disturbing the objective law. If the null event is caused by insufficient sampling data, β_{y} needs to be close to 1, that is, it is desirable to “artificially” increase the number of observation times to alleviate a null event caused by insufficient sampling data.

Specifically, as mentioned above, a dataset {N_{x|y}}_{x.y} and formula (5) are used to compute data {A_{xy}}ₓ of column y in the calibration matrix A . Data of the column essentially characterizes a probability distribution of an output result after a quantum state y is input. The number of zero elements in {A_{xy}}ₓ is denoted as K_{y}. Therefore, according to some embodiments, the correction coefficient β_{y} may be determined according to formula (7) and formula (8):

$${\text{β}}_{\text{y}} = \frac{\text{b}}{{K}_{\text{y}} + \text{a}}$$

$$0 \leq {β}_{y} \leq 1$$

Here. K_{y} is the number of zero elements of column y in the calibration matrix, and a and b are real numbers.

In some examples, values of a and b may be adaptively set as long as 0 ≤ β_{y} ≤ 1 is satisfied. For example, both a and b may be 1, that is, formula (7) may be expressed as formula (9):

$${\text{β}}_{\text{y}} = \frac{1}{{K}_{\text{y}} + 1}$$

It may be seen from formula (9): if K_{y} is large, that is, the number of zero elements in {A_{xy}}ₓ is large, it is considered that a null event in this case reflects the objective law of a measurement device, and therefore, corresponding β_{y} tends to 0; and if K_{y} is small, that is, the number of zero elements in {A_{xy}}ₓ is small, it is considered that a few null events are caused by insufficient sampling data, and therefore, corresponding β_{y} tends to 1. In a limit case, K_{y} = 0, and in this case. β_{y}=1. The number of observation times is increased artificially, so that a probability distribution tends to be uniform as possible, to characterize a calibration matrix better.

According to some embodiments, any suitable function may be used as a selection function of β_{y}, such as other optional functions including but not limited to a polynomial function, a logarithmic function, etc.

According to an embodiment of the present disclosure, the method for calibrating a quantum measurement device may include the following steps:
First step: A standard basis quantum state |y > is prepared by a calibration circuit, where y ∈ {0,1}ⁿ.
Second step: With |y > as input, a noisy measurement device is repeatedly operated Nₛₕₒₜₛ times, and the number of times N_{x|y} output results are binary strings x is counted, where x ∈ {0,1}ⁿ.
Third step: Elements {A_{xy}}ₓ of column y in a calibration matrix A are obtained by using a dataset {N_{x|y}}_{x,y} and formula (5).
Fourth step: The number of zero elements in {A_{xy}}ₓ is counted as K_{y}. Based on K_{y}, β_{y} is obtained according to formula (9).
Fifth step: Elements of column y in a new calibration matrix A̅ are computed by using a dataset {N_{x|y}}_{x.y} and β_{y.} It is assumed that A̅_{xy} represents an element of row x and column y in a 2ⁿ × 2ⁿ matrix A̅, and has a value as follows:
$${\overline{A}}_{x y} = \frac{{N}_{\left(x\right| y} + {β}_{y}}{{N}_{s h o t s} + {2}^{n} {β}_{y}}$$
All
$$x ∈ {\left\{0 , 1\right\}}^{\text{n}}$$
may be enumerated to obtain all elements of column y in A̅. Formula (4) ensures that column y in the calibration matrix A̅ constructed as above satisfies a column random property.
Sixth step: The foregoing five steps are repeated until elements of all columns in the calibration matrix A̅ are computed.

According to the embodiments of the present disclosure, a correction coefficient is determined, and each element of a new calibration matrix is computed through the additive smoothing technology, so that a possible “null event” is systematically avoided, and the new calibration matrix has higher calibration accuracy and robustness.

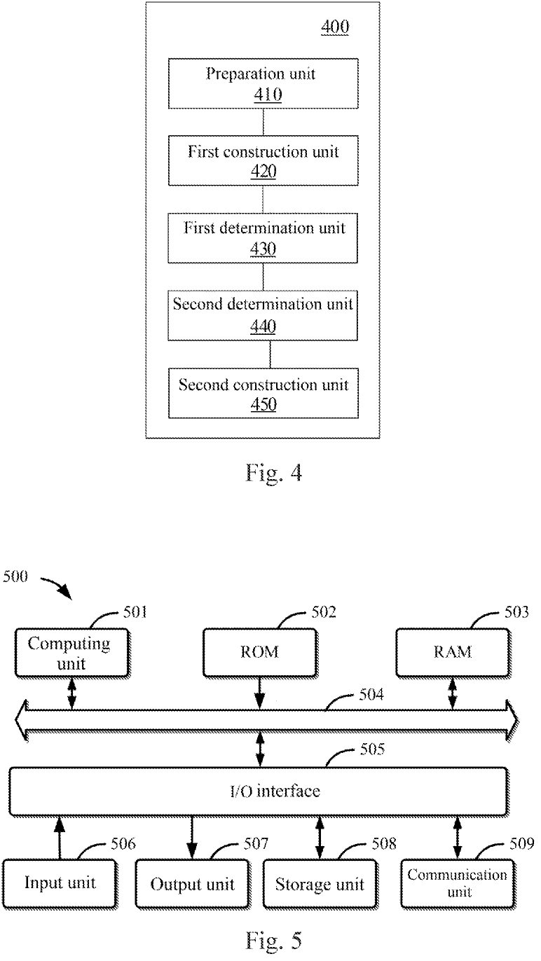

According to an embodiment of the present disclosure, as shown in FIG. 4, there is further provided an apparatus 400 for calibrating a quantum measurement device, the apparatus including: a preparation unit 410 configured to prepare one or more standard basis quantum states |y >, and for each of the standard basis quantum states, repeatedly operating a measurement device a predetermined number of times to perform measurements on that the each standard basis quantum state, to obtain the predetermined number of measurement results, where

$$y ∈ {\left\{0 , 1\right\}}^{\text{n}}$$

, n is the number of qubits of a quantum computer, and n is a positive integer; a first construction unit 420 configured to count the predetermined number of measurement results, of each of the standard basis quantum states, to construct a calibration matrix: a first determination unit 430 configured to determine the number of zero elements of each column in the calibration matrix; a second determination unit 440 configured to determine a correction coefficient corresponding to the each column on the basis of the number of zero elements, where the correction coefficient is inversely proportional to the number of zero elements; and a second construction unit 450 configured to construct a new calibration matrix on the basis of the correction coefficient corresponding to the each column, to correct a measurement result of the measurement device on the basis of the new calibration matrix.

Herein, operations of all the foregoing units 410 to 450 of the apparatus 400 for calibrating a quantum measurement device are respectively similar to operations of steps 310 to 350 described above. Details are not described herein again.

According to the embodiments of the present disclosure, there are further provided an electronic device, a readable storage medium, and a computer program product.

Referring to FIG. 5, a structural block diagram of an electronic device 500 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 5, the device 500 includes a computing unit 501, which may perform various appropriate actions and processing according to a computer program stored in a read-only memory (ROM) 502 or a computer program loaded from a storage unit 508 to a random access memory (RAM) 503. The RAM 503 may further store various programs and data required for the operation of the device 500. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, an output unit 507, the storage unit 508. and a communication unit 509. The input unit 506 may be any type of device capable of entering information to the device 500. The input unit 506 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disc. The communication unit 509 allows the device 500 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 1302.11 device, a Wi-Fi device, a WiMAX device, a cellular communication device and/or the like.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described above, for example, the method 300. For example, in some embodiments, the method 300 may be implemented as a computer software program, which is tangibly contained in a machine-readable medium, such as the storage unit 508. In some embodiments, a part or all of the computer program may be loaded and/or installed onto the device 500 via the ROM 502 and/or the communication unit 509. When the computer program is loaded onto the RAM 503 and executed by the computing unit 501, one or more steps of the method 300 described above can be performed. Alternatively, in other embodiments, the computing unit 501 may be configured, by any other suitable means (for example, by means of firmware), to perform the method 300.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a key board and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the drawings, it should be appreciated that the methods, systems, and devices described above are merely exemplary embodiments or examples, and the scope of the present invention is not limited by the embodiments or examples, but only defined by the appended authorized claims and equivalent scopes thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed to:

1. A method performed by an electronic device, the method comprising:
preparing one or more standard basis quantum states denoted by |y >;
for each of the standard basis quantum states, repeatedly operating a measurement device a predetermined number of times to perform measurements on the each standard basis quantum state, to obtain the predetermined number of measurement results, where y ∈ {0,1}ⁿ, n is the number of qubits of a quantum computer, and n is a positive integer;
counting the predetermined number of measurement results, of each of the standard basis quantum states, to construct a calibration matrix;
determining the number of zero elements of each column in the calibration matrix;
determining a correction coefficient corresponding to the each column based on the number of zero elements, wherein the correction coefficient is inversely proportional to the number of zero elements: and
constructing a new calibration matrix based on the correction coefficient corresponding to the each column, to correct a measurement result of the measurement device based on the new calibration matrix.

2. The method according to claim 1, wherein the correction coefficient denoted by β_{y} is determined according to the following formula:
$$\begin{matrix}{β}_{\text{y}} = \frac{\text{b}}{{K}_{\text{y}} + a} \\ 0 \leq {β}_{\text{y}} \leq 1\end{matrix}$$
where K_{y} is the number of zero elements of column y in the calibration matrix, and a and b are real numbers.

3. The method according to claim 1. wherein the correction coefficient denoted by β_{y} is determined according to any one of the following: a polynomial function and a logarithmic function.

4. The method according to claim 1, wherein the new calibration matrix is constructed according to the following formula:
$${\overline{A}}_{x y} = \frac{{N}_{x \vert \text{y}} + {β}_{\text{y}}}{{N}_{s h o t s} + {2}^{n} {β}_{\text{y}}}$$
where A̅_{xy} is an element of row x and column y in the new calibration matrix, N_{x|y} is the number of times that the measurement result is obtained of x after inputting a standard basis quantum state |y >, Nₛₕₒₜₛ is the predetermined number of times, and β_{y} is a correction coefficient corresponding to the column y.

5. An electronic device, comprising:
a memory storing one or more programs configured to be executed by one or more processors, the one or more programs including instructions for causing the electronic device to perform operations comprising:
preparing one or more standard basis quantum states denoted by |y >;
for each of the standard basis quantum states, repeatedly operating a measurement device a predetermined number of times to perform measurements on the each standard basis quantum state, to obtain the predetermined number of measurement results, where y ∈ {0,1}ⁿ, n is the number of qubits of a quantum computer, and n is a positive integer;
counting the predetermined number of measurement results, of each of the standard basis quantum states, to construct a calibration matrix;
determining the number of zero elements of each column in the calibration matrix;
determining a correction coefficient corresponding to the each column based on the number of zero elements, wherein the correction coefficient is inversely proportional to the number of zero elements: and
constructing a new calibration matrix based on the correction coefficient corresponding to the each column, to correct a measurement result of the measurement device based on the new calibration matrix.

6. The electronic device according to claim 5, wherein the correction coefficient denoted by β_{y} is determined according to the following formula:
$$\begin{matrix}{β}_{\text{y}} = \frac{\text{b}}{{K}_{\text{y}} + a} \\ 0 \leq {β}_{\text{y}} \leq 1\end{matrix}$$
where K_{y} is the number of zero elements of column y in the calibration matrix, and a and b are real numbers.

7. The electronic device according to claim 5, wherein the correction coefficient denoted by β_{y} is determined according to any one of the following: a polynomial function and a logarithmic function.

8. The electronic device according to claim 5, wherein the new calibration matrix is constructed according to the following formula:
$${\overline{A}}_{x \text{y}} = \frac{{N}_{x \vert y} + {β}_{\text{y}}}{{N}_{s h o t s} + {2}^{n} {β}_{\text{y}}}$$
where A̅_{xy} is an element of row x and column y in the new calibration matrix, N_{x|y} is the number of times that the measurement result is obtained of x after inputting a standard basis quantum state |y >, Nₛₕₒₜₛ is the predetermined number of times, and β_{y} is a correction coefficient corresponding to the column y.

9. A non-transitory computer-readable storage medium that stores one or more programs comprising instructions that, when executed by one or more processors of an electronic device, cause the electronic device to perform operations comprising:
preparing one or more standard basis quantum states denoted by |y >;
for each of the standard basis quantum states, repeatedly operating a measurement device a predetermined number of times to perform measurements on the each standard basis quantum state, to obtain the predetermined number of measurement results, where y ∈ {0,1}ⁿ, n is the number of qubits of a quantum computer, and n is a positive integer,
counting the predetermined number of measurement results, of each of the standard basis quantum states, to construct a calibration matrix;
determining the number of zero elements of each column in the calibration matrix;
determining a correction coefficient corresponding to the each column based on the number of zero elements, wherein the correction coefficient is inversely proportional to the number of zero elements; and
constructing a new calibration matrix based on the correction coefficient corresponding to the each column, to correct a measurement result of the measurement device based on the new calibration matrix.

10. The non-transitory computer-readable storage medium according to claim 9, wherein the correction coefficient denoted by β_{y} is determined according to the following formula:
$$\begin{matrix}{β}_{\text{y}} = \frac{\text{b}}{{K}_{\text{y}} + \text{a}} \\ 0 \leq {β}_{\text{y}} \leq 1\end{matrix}$$
where K_{y} is the number of zero elements of column y in the calibration matrix, and a and b are real numbers.

11. The non-transitory computer-readable storage medium according to claim 9, wherein the correction coefficient β_{y} is determined according to any one of the following: a polynomial function and a logarithmic function.

12. The non-transitory computer-readable storage medium according to claim 9, wherein the new calibration matrix is constructed according to the following formula:
$${\overline{A}}_{x y} = \frac{{N}_{x \vert y} + {β}_{y}}{{N}_{s h o t s} + 2 ” {β}_{y}}$$
where A̅_{xy} is an element of row x and column y in the new calibration matrix. N_{x|y} is the number of times that the measurement result is obtained of x after inputting a standard basis quantum state |y >, Nₛₕₒₜₛ is the predetermined number of times, and β_{y} is a correction coefficient corresponding to the column y.
